(19) United States
(12) Patent Application Publication
(10) Pub. No.: US 2006/0279621 A1
(43) Pub. Date: Dec. 14, 2006

(54) Ink-jet recording method and recording medium used therein

(76) Inventor: Naoya Morohoshi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/557,486

(22) PCT Filed: Jun. 2, 2004
(86) PCT No.: PCT/JP04/07995

§ 371 Date: Nov. 21, 2005

(30) Foreign Application Priority Data
Jun. 3, 2003 (JP) 2003-158507
May 31, 2004 (JP) 2004-162241

(51) Int. Cl. B41J 2/01

(52) U.S. Cl. 347/104

(57) ABSTRACT

An ink-jet recording method for performing recording on a recording medium by attaching ink thereto with the recording medium adhering to a conveyor belt because of electrostatic attraction thereto is disclosed. In this method, the electrostatic attraction is caused by a charging unit that applies AC bias to the conveyor belt so that positive and negative charges are provided on the conveyor belt so as to alternate with each other in a direction in which the conveyor belt moves. The surface of the recording medium which surface comes into contact with the conveyor belt has surface resistivity that falls within a range of 1 to 9.

### TECHNICAL FIELD

The present invention relates generally to ink-jet recording methods according to which ink is ejected to perform recording on a recording medium and recording media used in the ink-jet recording methods, and more particularly to an ink-jet recording method and an ink-jet recording medium suitable therefor, according to which method a bias is applied to an endless conveyor belt to convey a recording medium to a predetermined position by an electrostatic attraction force, and ink (recording liquid) is ejected from a recording part (recording head) to the recording medium so that recording is performed thereon.

### BACKGROUND ART

Ink-jet recording, according to which ink is ejected from a recording head to a recording medium (a material on which recording is performed) so as to perform recording thereon, can achieve high-speed recording of a high-definition image. Accordingly, ink-jet recording is employed in facsimile machines, copiers, and printers.

In ink-jet recording, the pursuit of higher image quality requires ink droplets to be ejected onto a recording medium with higher positional accuracy, which also requires accuracy of conveyance of the recording medium. According to an ink-jet recording serial printer, a recording medium is stopped during scanning by a head. The feeding of the recording medium is by repetition of movement and stoppage of the recording medium. The feeding accuracy of the recording medium conveyance is the accuracy of a position at which the recording medium is stopped after being fed by a predetermined amount.

In the case of forming an image on a recording medium by ink-jet recording, if the recording medium is paper such as coated paper having an ink absorbing layer formed on plain paper or a paper base, the paper is caused to stretch by moisture included in ink. This phenomenon is called cockling. This cockling causes the paper to undulate, so that the distance between the nozzles of a recording head and the surface of the paper differs by positions on the paper. If cockling worsens, in the worst case, the paper may come into contact with the nozzle face of the recording head so that not only the nozzle face but also the paper itself is contaminated. Further, cockling may cause ink droplets to be ejected onto wrong (offset) positions.

Therefore, according to the conventional ink-jet recording, printing is performed on a platen provided with a recess absorbing the cockling of paper, and a spur is provided to hold the paper. Here, the spur is a gear-like part, having projections formed circumferentially on its outer surface. The spur helps to convey the paper with the small area of one or more of the projections. However, scratches made on an image by the spur cause a problem in some cases.

Further, according to the conventional ink-jet recording, paper is fed by rollers. Two pairs of rollers, one of the above-described spur and a roller and the other of a conveying roller and a driven roller, are provided to sandwich a printing region. According to this configuration, paper feeding accuracy can be guaranteed only when the two pairs of rollers are biting (engaging) the paper.

In these days, there is a demand for enlarging an image printing region. In order to ensure this printing region, some printers perform printing even in a state where paper feeding accuracy cannot be guaranteed under ordinary circumstances, that is, in a state where only one of the two pairs of rollers is biting the paper. With only one of the two roller pairs biting the paper, it is impossible to cope with paper floating or ensure a paper conveying force. Accordingly, it is impossible to ensure paper feeding accuracy, thus resulting in reduced image quality.

At present, an electrostatic attraction force is employed in many cases to convey a recording medium in order to increase the accuracy of recording medium conveyance.

For instance, Japanese Patent No. 2873879 discloses an ink-jet recording apparatus having an electrostatic attraction conveyance member conveying a material on which recording is performed and a cleaning member cleaning the electrostatic attraction conveyance member using liquid higher in electric resistance than ink. The cleaning member is provided in order to clean conductive ink having adhered to the electrostatic attraction conveyance member (such as a belt or a drum), thereby preventing the surface resistance of the electrostatic attraction conveyance member from decreasing as much as possible.

This ink-jet recording apparatus includes a cleaning member that is complicated in structure. Accordingly, the ink-jet recording apparatus is inevitably large in size and costly.

Japanese Patent No. 2915450 discloses a conveyor belt having a specific high resistance layer of 50 μm in thickness on its outer surface and having its inner surface grounded through an idle roller. The outer surface of the conveyor belt is charged to approximately 1500 V. However, when this conveyor belt is used, a negative charge is injected into a recording medium from another power supply. Accordingly, there is the disadvantage that two different power supplies should be prepared. According to Japanese Patent No. 3014815, different charges are injected separately into a conveyor belt and a recording medium.

Further, Japanese Patent No. 3124668 discloses an electrostatic attraction unit for providing electrostatic attraction to a conveyor belt. The electrostatic attraction unit includes a pair of spaced electrodes, a circuit for applying voltage between the electrodes, and a circuit for supplying current for causing at least one of the paired electrodes to generate heat. According to this electrostatic attraction unit, a voltage is applied between the paired electrodes to generate an electrostatic force between the electrodes so that a material on which recording is performed is attracted and adhered to the conveyor belt. This electrostatic attraction unit is different from those providing an electric charge directly to the conveyor belt.

On the other hand, in the case where a recording medium having an ink absorbing layer provided on a base body of high surface resistivity, such as a plastic film, is conveyed, being electrostatically attracted and adhering to an electrostatic attraction conveyor belt, the surface charge of the recording medium has difficulty in moving when the recording medium is separated from the conveyor belt. As a result, separating discharge occurs with an electric charge on the conveyor belt. Once the separating discharge occurs, the surface of the recording medium which surface has been in contact with the conveyor belt is charged. As a consequence, the recording medium that is being conveyed electrostatically adheres to recording media that have been ejected and stacked in a paper ejection tray. This may cause the recording media on which recording has already been performed to be pushed out, or may generate resistance against the conveyance of the recording medium that is being conveyed, thus adversely affecting the conveyability of the recording medium.

This problem of the adverse effect on conveyability remains unsolved in the above-described electrostatic attraction devices.

### DISCLOSURE OF THE INVENTION

Accordingly, it is a general object of the present invention to provide an ink-jet recording method in which the above-described disadvantages are eliminated.

A more specific object of the present invention is to provide an ink-jet recording method by which a recording medium is conveyed satisfactorily using an electrostatic attraction force and in which an improvement is made in recording medium stackability in a paper ejection tray part after recording in the case of performing recording on recording media having an ink absorbing layer provided on a base body such as a plastic film.

Another more specific object of the present invention is to provide a recording medium suitable for such an ink-jet recording method.

One or more of the above objects of the present invention are achieved by an ink-jet recording method for performing recording on a recording medium by attaching ink thereto, the recording medium adhering to a conveyor belt because of electrostatic attraction thereto, wherein: the electrostatic attraction is caused by a charging unit, the charging unit applying AC bias to the conveyor belt so that positive and negative charges are provided on the conveyor belt so as to alternate with each other in a direction in which the conveyor belt moves; and a surface of the recording medium which surface comes into contact with the conveyor belt has surface resistivity that falls within a range of 1×10⁹ to 9×10¹²Ω.

According to the above-described ink-jet recording method, image quality can be improved without providing a spur on the side of the printing surface of the recording medium. Further, cockling, which may occur when the recording medium is plain paper or coated paper having an ink absorbing layer formed on a paper base, can be controlled. Furthermore, the stackability of the recording medium after recording can be improved.

One or more of the above objects of the present invention are also achieved by a recording medium to be employed in an ink-jet recording method for performing recording on the recording medium by attaching ink thereto, the recording medium adhering to a conveyor belt because of electrostatic attraction thereto, wherein: a surface of the recording medium which surface comes into contact with the conveyor belt has surface resistivity that falls within a range of 1×10⁹ to 9×10¹²Ω.

According to the above-described recording medium, paper transportation can be performed smoothly. As a result, good image quality can be obtained.

### BRIEF DESCRIPTION OF THE DRAWINGS

Other objects, features and advantages of the present invention will become more apparent from the following detailed description when read in conjunction with the accompanying drawings, in which:

FIG. 1 is a schematic diagram for illustrating an ink-jet recording method using a line printer according to an embodiment of the present invention;

FIG. 2 is a diagram for illustrating the relationship between the positions of a line head and a paper sheet according to the embodiment of the present invention;

FIGS. 3A and 3B are a bottom view and a side view, respectively, of the line head according to the embodiment of the present invention;

FIG. 4 is a schematic diagram for illustrating attraction and adhesion to a double-layer conveyor belt according to the embodiment of the present invention;

FIG. 5 is a schematic diagram showing the conveyor belt in a charged state according to the embodiment of the present invention;

FIG, 6 is a schematic diagram for illustrating an ink-jet recording method using a serial printer according to the embodiment of the present invention;

FIG. 7 is a diagram showing a rotary encoder provided to the shaft of a conveyor roller according to the embodiment of the present invention;

FIG. 8 is a diagram for illustrating the rotary encoder according to the embodiment of the present invention;

FIG. 9 is a schematic diagram for illustrating a case where a linear encoder is formed on the conveyor belt and the encoder is read by a reflection sensor according to the embodiment of the present invention;

FIGS. 10A and 10B are diagrams for illustrating the linear encoder formed on the conveyor belt according to the embodiment of the present invention;

FIG. 11 is a plan view of the linear encoder according to the embodiment of the present invention;

FIG. 12 is a schematic diagram showing an example of the reading of an encoder by a reflection sensor according to the embodiment of the present invention;

FIG. 13 is a schematic diagram showing another example of the reading of an encoder by a reflection sensor according to the embodiment of the present invention;

FIG. 14 is a schematic diagram showing an example of the reading of an encoder by a transmission sensor according to the embodiment of the present invention;

FIG. 15 is a schematic diagram for illustrating the relationship between a reflection sensor and motor control according to the embodiment of the present invention;

FIG. 16 is a schematic diagram for illustrating attraction and adhesion to a single-layer conveyor belt for comparison;

FIG. 17 is a schematic diagram showing the conveyor belt for comparison in a charged state;

FIG. 18 is a diagram showing an operation of a serial-type head according to the embodiment of the present invention;

FIG. 19 is a flowchart for illustrating timing for applying AC bias to the conveyor belt according to the embodiment of the present invention;

FIG. 20 is a flowchart for illustrating timing for applying AC bias to the conveyor belt according to the embodiment of the present invention;

FIG. 21 is a schematic diagram showing a conveyance unit employing a grip roller according to the embodiment of the present invention;

FIG. 22 is a schematic diagram showing the grip roller according to the embodiment of the present invention;

FIG. 23 is a schematic diagram showing a conveyor belt including a timing belt part according to the embodiment of the present invention; and

FIG. 24 is a schematic diagram showing an application of the conveyor belt of FIG. 23 according to the embodiment of the present invention.

### BEST MODE FOR CARRYING OUT THE INVENTION

A description is given below, with reference to the accompanying drawings, of an embodiment of the present invention.

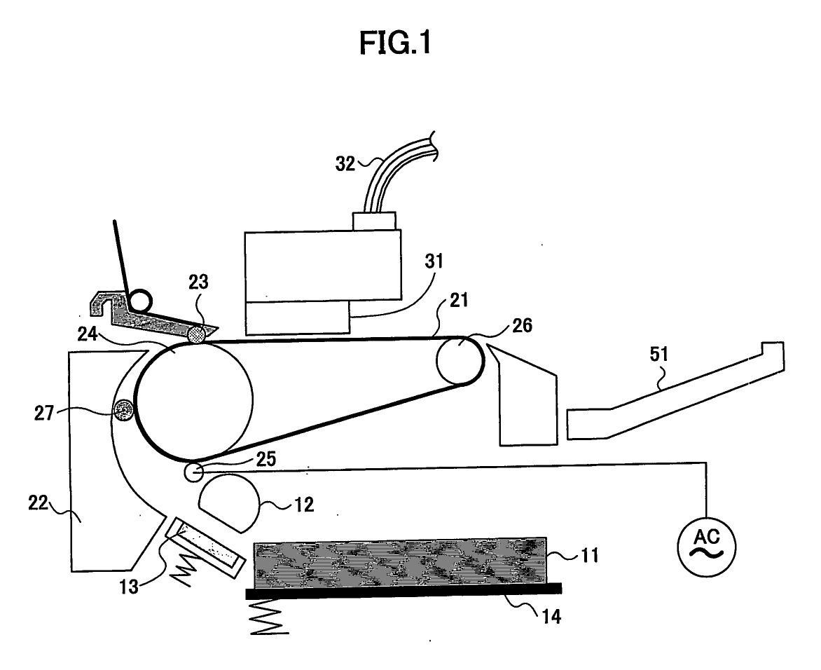

FIG. 1 is a schematic diagram for illustrating an ink-jet recording method using a line printer according to the embodiment of the present invention. Referring to FIG. 1, the line printer includes a line head 31 in a position opposite a conveyor belt 21 that can convey paper (recording media) 11 with high accuracy. Ink is supplied to the head 31 through an ink supply tube 32 from an ink tank disposed at a different position. The paper 11 is picked up by a paper feed roller 12 to be separated by a paper separation pad 13. Each separated sheet of paper (recording medium) 11 is conveyed along a conveyance guide 22, and is fed to a printing position by the rotation of a conveyor roller 24, being pinched between the conveyor belt 21 and edge rollers 23.

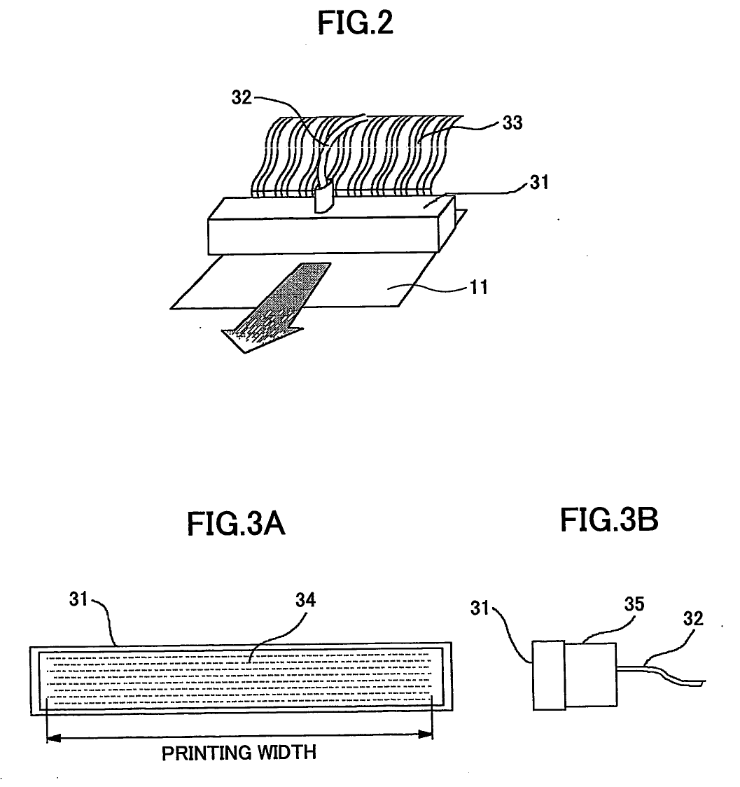

FIG. 2 is a diagram for illustrating the relationship between the positions of the head 31 and the paper sheet 11. Referring to FIG. 2, the width of the head 31 covers the width of the paper sheet 11. Head driving signal lines 33 are connected to the head 31.

FIGS. 3A and 3B are a bottom view and a side view, respectively, of the head 31. Referring to FIG. 3A, the density of nozzle arrays 34 is equal to the density of an image to be formed. The nozzle arrays 34 are arranged in the direction in which the paper sheet 11 is conveyed. If the head 31 supports multi-color printing, the head 31 includes at least three nozzle arrays each dedicated to a different color. Referring to FIG. 3B, the head 31 is supported by a head support frame 35.

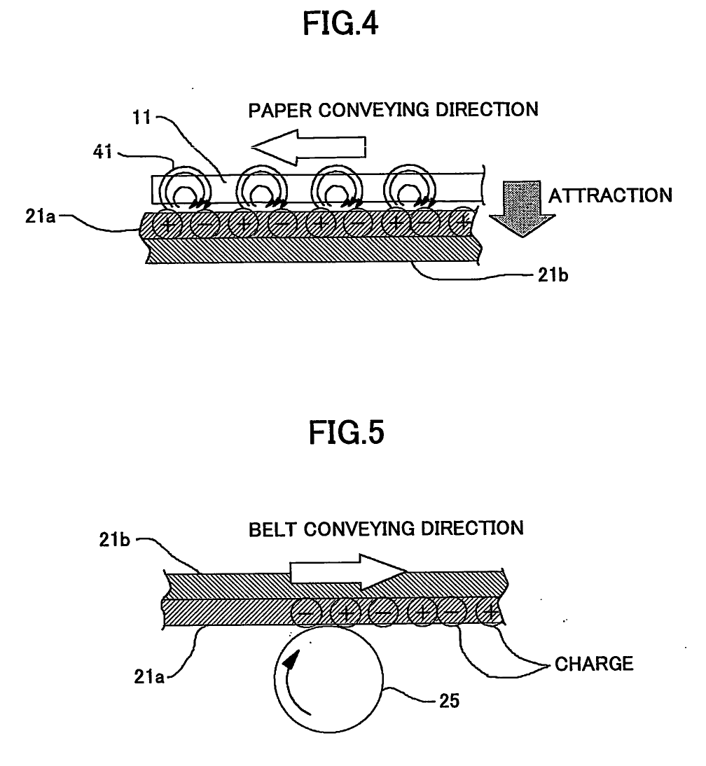

FIG. 4 is a schematic diagram for illustrating attraction and adhesion to the conveyor belt 21. Referring to FIG. 4, the conveyor belt 21 has a double-layer structure of an insulating layer 21a and a conductive layer 21b. Preferably, the insulating layer 21a is 20 to 100 μm in thickness and the conductive layer 21b is 30 to 200 μm in thickness. Each of the insulating and conductive layers 21a and 21b is essentially made of resin or elastomer. The insulating layer 21a, which is positioned on the paper contact side, is made of a pure resin or elastomer material that does not include a conduction control material to have a volume resistivity of 1.0×10¹²Ω·cm or more. The insulating layer 21a desirably has a volume resistivity of 1.0×10¹⁵Ω·cm or more in terms of charge stability with respect to a charging environment. The conveyor belt 21 may be made of a commonly known material such as PET (polyethylene terephthalate), PEI (polyetherimide), PVDF (polyvinylidenefluoride), PC (polycarbonate), ETFE (ethylene-tetrafluoroethylene copolymer), or PTFE (polytetrafluoroethylene). The volume resistivity of 1.0×10¹⁵Ω·cm or more is also achievable with any of the above-described materials. The conductive layer 21b is formed by including a conduction control agent in the pure material so as to have a volume resistivity of 1.0×10⁵ to 10⁷Ω·cm. The conduction control agent may be particles of carbon, a metal oxide such as zinc oxide, titanium oxide, molybdenum oxide, antimony oxide, or indium oxide, or a dopant (doping material).

When positive and negative AC voltages are applied to the conveyor belt 21 having the above-described structure, positive (+) belts and negative (−) belts are alternately formed in the insulating layer 21a of the conveyor belt 21 to create alternating fields passing through the paper sheet 11 as shown in FIG. 4, thereby obtaining a force to attract and adhere the paper sheet 11 to the conveyor belt 21.

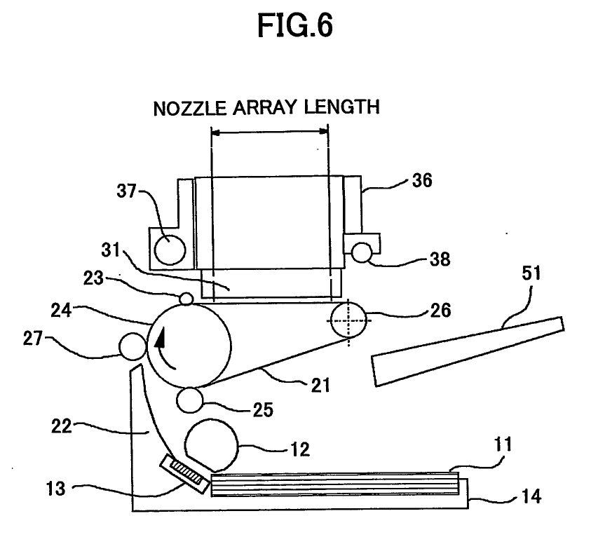

FIG. 5 is a schematic diagram showing the conveyor belt 21 in a charged state. Referring to FIG. 5, the conveyor belt 21 is charged by causing a charging roller 25 to come into contact with the insulating layer 21a side of the moving conveyor belt 21 and supplying an AC voltage of 1500 to 3500 V to the charging roller 25.

Referring to FIG. 1, the conveyor belt 21 runs between the conveyor roller 24 and a tension roller 26 with the edge rollers 23 being positioned opposite the conveyor roller 24 so as to be able to apply pressure in a direction toward the conveyor roller 24. The paper 11 is picked up from a paper stacking tray 14 by the paper feed roller 12, and is guided sheet by sheet to the conveyance guide 22 by the paper separation pad 13. At this point, electric charges have been injected into the conveyor belt 21 by the charging roller 25 so that the paper sheet 11 is electrostatically attracted to the conveyor belt 21.

It is well known, however, that an electrostatic attraction force is extremely reduced when the distance to an object of attraction becomes great.

The paper sheet 11 is pressed against the conveyor belt 21 by the edge rollers 23 to receive an efficient electrostatic attraction force. As a result, the paper sheet 11 is conveyed to a printing part, being superimposed on the conveyor belt 21 with no space therebetween.

FIG. 6 is a schematic diagram for illustrating an ink-jet recording method using a serial printer according to the embodiment of the present invention. In FIG. 6, the same elements as those of FIG. 1 are referred to by the same numerals.

Referring to FIG. 6, the paper feed roller 12 feeding the paper 11 and the paper separation pad 13 separating the paper 11 sheet by sheet form a paper supplying part. The paper sheet 11 can be fed with accuracy, being pinched between the edge rollers 23 and the conveyor roller 24 through the conveyor belt 21. The conveyor belt 21 supports the paper sheet 11 from its bottom side in a printing part. The paper 11 picked up by the paper feed roller 12 is separated sheet by sheet by the paper separation pad 13, and is conveyed to reach the nip between the conveyor roller 24 and the edge rollers 23. Thereafter, the paper sheet 11 is conveyed to a position where printing is performed by the head 31. Then, a carriage 36 holding the head 31 performs scanning so that an image of the nozzle resolution of the head 31 is formed on the paper sheet 11. After the printing is over, the conveyor roller 24 is rotated to convey the paper sheet 11 a predetermined distance to a position where the next line is printed. When the paper sheet is scanned by the carriage 36, the carriage 36 moves along a carrier guide 38 and the movement of the carriage 36 is stopped by a carrier guide lock 37.

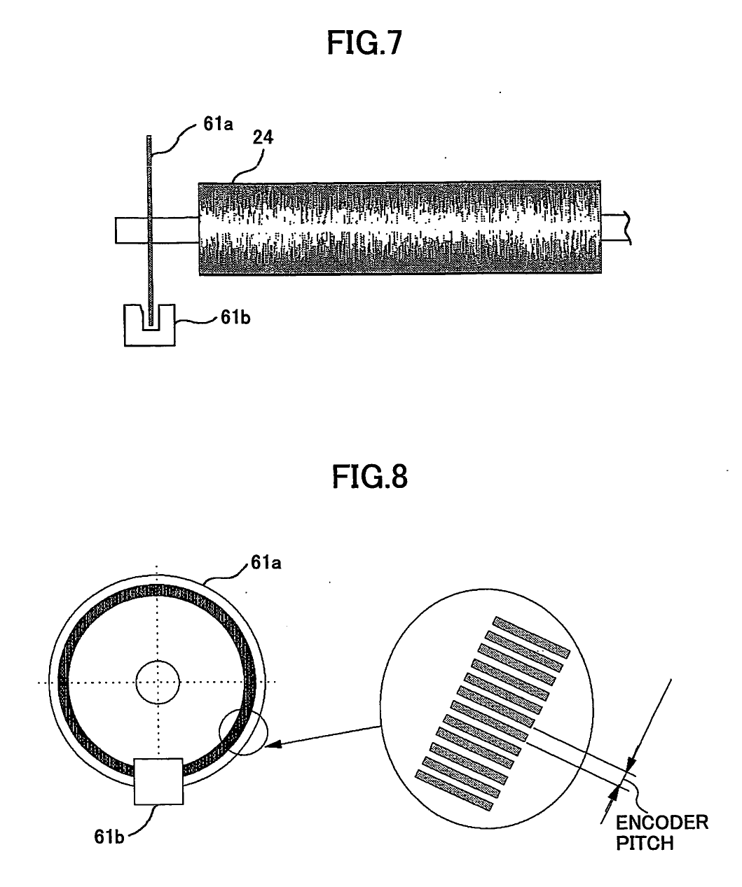

In this paper conveyance path, a rotary encoder 61a is provided to the shaft of the conveyor roller 24 as shown in FIG. 7. Further, an encoder reading sensor 61b of a transmission type is also provided. That is, the rotation of the conveyor roller 24 is obtained as pulses from the rotary encoder 61a. FIG. 8 is a diagram for illustrating the rotary encoder 61a. Referring to FIG. 8, minute lines are formed circumferentially on the edge part of the rotary encoder 61a. An encoder pitch shown enlarged in FIG. 8 is commonly known to be 100 LPI (line per inch), 150 LPI, 200 LPI, or 300 LPI.

As the encoder reading sensor 61b, a common encoder reading sensor that outputs pulses four times those actually output from an encoder is known. For instance, in the case of an encoder with 2400 lines per rotation, 9600 pulses may be obtained when a sensor that can output four times as much as the encoder is employed. A motor that drives the conveyor roller 24 is subjected to pulse-managed control based on the output of the encoder 61a so as to perform paper feeding of a desired amount (distance). The minimum unit of the conveyance of the paper sheet 11 is the highest image density (resolution) outputtable by the printer including this device. For instance, in the case of a 600 dpi printer, the minimum unit of feeding is 25.4 mm/600=42.3 μm. In practice, feeding of an integral multiple of 42.3 μm is performed. In the printer of FIG. 6, the diameter of the conveyor roller 24 is set so that feeding per single output pulse of the encoder 61a corresponds to the highest image density. Accordingly, control is performed with a unit of control being the highest image density.

An example of this is shown below.

It is assumed that control is performed based on a signal four times the output of the encoder 61a of 2400 pulses per rotation. In this case, the number of output pulses obtained from a rotation of the encoder 61a is 2400×4=9600. Provided that the highest image density of the printer is 1200 dpi, then the minimum unit of feeding is 25.4 mm/1200=21.2 μm. Since the encoder 61a rotates once when the conveyor roller 24 rotates once, a roller diameter φ of 64.5 mm is obtained from the following equation:
(φ×π)/9600=21.2 μm. (1)
That is, by providing the encoder 61a of 2400 pulses per rotation to the shaft of the conveyor roller 24 of 64.5 mm in diameter, a paper feed unit that performs feeding of 21.2 μm per pulse for control can be realized.

Alternatively, the diameter of the conveyor roller 24 may be set so that feeding per single pulse of the encoder 61a is a quotient obtained by dividing the highest image density of the printer by n (n=an integer≧2). An example of this is shown below.

It is assumed that control is performed based on a signal four times the output of the encoder 61a of 2400 pulses per rotation. In this case, the number of output pulses obtained from a rotation of the encoder 61a is 2400×4=9600. Provided that the highest image density of the printer is 1200 dpi, then the minimum unit of feeding is 25.4 mm/1200=21.2 μm. In this case, a unit of control is a value obtained by dividing 21.2 μm by n (for instance, 2), that is, 21.2/2=10.6 μm. Since the encoder 61a rotates once when the conveyor roller 24 rotates once, a roller diameter φ of 32.4 mm is obtained from the following equation:
(φ×π)/9600=10.6 μm. (2)
That is, by providing the encoder 61a of 2400 pulses per rotation to the shaft of the conveyor roller 24 of 32.4 mm in diameter, a paper feed unit that performs feeding of 10.6 μm per pulse for control can be realized. As a result, even if there is a single pulse error in control, it is possible to prevent an image from being affected by the error.

Thus, feeding control can be performed with higher accuracy (resolution).

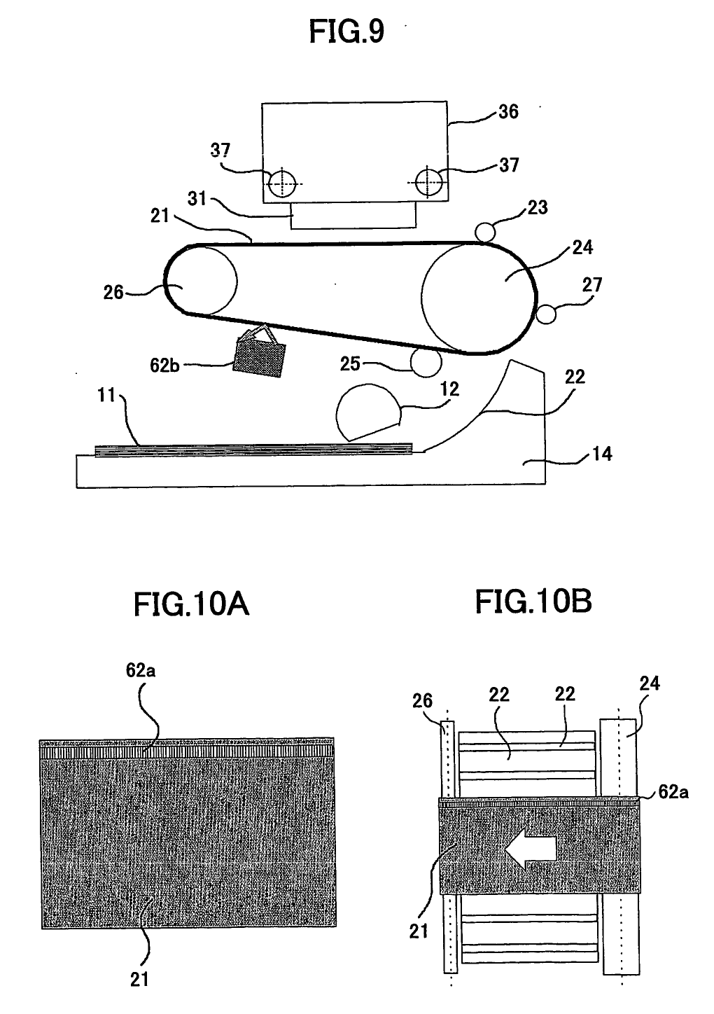

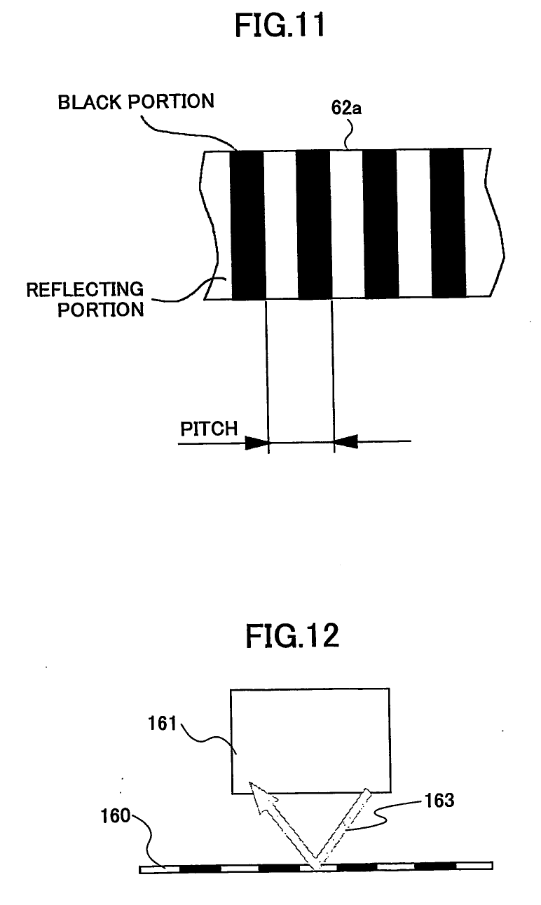

Next, FIG. 9 is a schematic diagram for illustrating the case where a linear encoder 62a is formed on the conveyor belt 21 and the encoder 62a is read by a reflection sensor (an encoder reading sensor of a reflection type) 62b. In FIG. 9, the same elements as those of FIG. 6 are referred to by the same numerals. In this case, referring to FIG. 10A, the linear encoder 62a is provided to an edge part of the insulating layer 21a of the conveyor belt 21 along its length. FIG. 10B is a diagram showing an example of the relationship between the positions of the conveyor belt 21 and other parts such as the conveyor roller 24. Referring to FIG. 11, the linear encoder 62a has black portions and reflecting portions formed alternately at the same pitch.

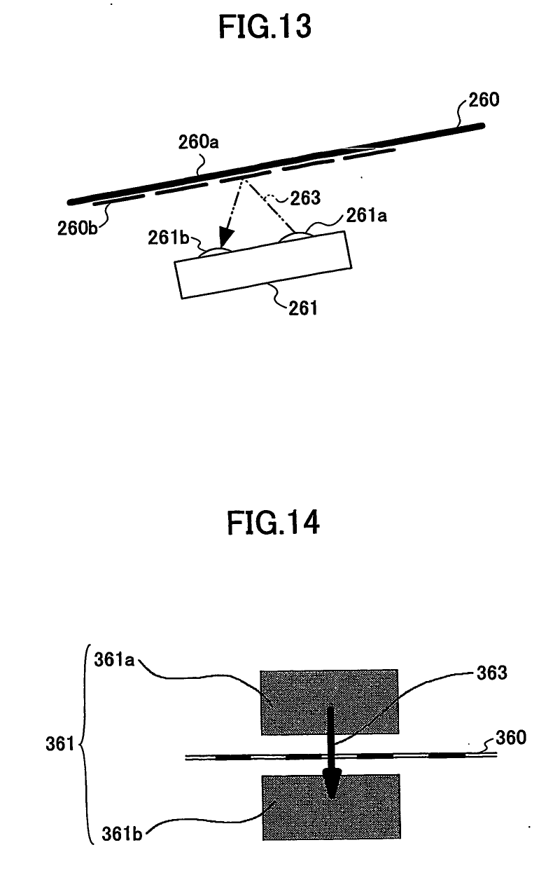

FIGS. 12 and 13 are schematic diagrams showing examples of the reading of an encoder by a reflection sensor. Referring to FIG. 12, the light emitted from the light emission part (for instance, an LED) of a reflection sensor 161 is reflected back from a reflecting portion of an encoder 160 to enter the light reception part of the reflection sensor 161 in a sensor (LED) light path 163. Referring to FIG. 13, an encoder 260 includes a non-reflecting portion 260a and a reflecting portion 260b. The light emitted from a light emission part (for instance, an LED) 261a of a reflection sensor 261 is reflected back from the reflecting portion 260b of the encoder 260 to enter a light reception part 261b of the reflection sensor 261 in a sensor (LED) light path 263.

On the other hand, FIG. 14 is a schematic diagram showing an example of the reading of an encoder 360 by a transmission sensor 361. The transmission sensor 361 includes a light emission part (for instance, an LED) 361a and a light reception part 361b. The light emitted from the light emission part 361a travels through a transparent portion of the encoder 360 to enter the light reception part 361b in a sensor (LED) light path 363.

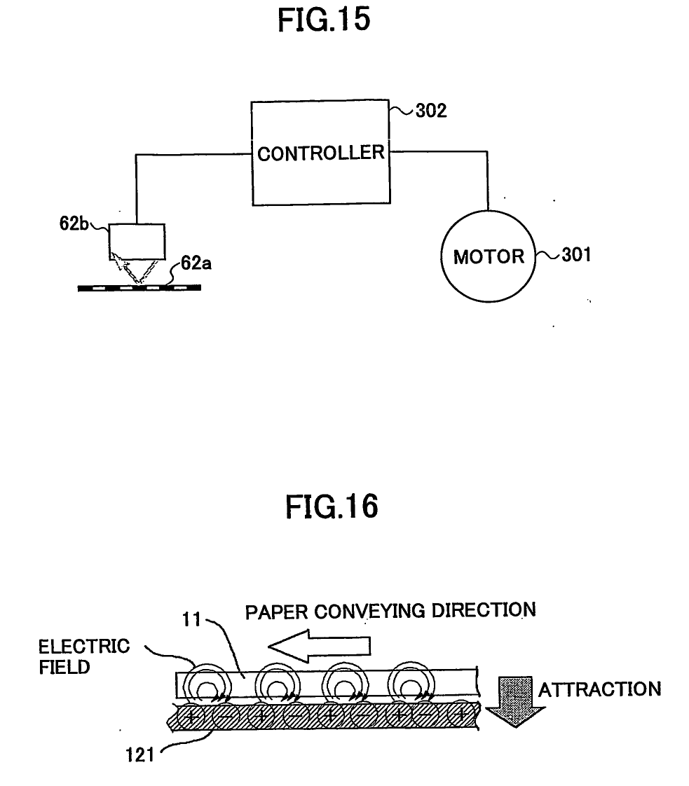

FIG. 15 is a schematic diagram for illustrating the relationship between the reflection sensor 62b and motor control. A motor 301 driving the conveyor roller 24 is connected to a controller 302, to which the reflection sensor 62b is connected. The motor 301 is subjected to pulse-managed control by the controller 302 based on the output of the encoder 62a through the sensor 62b so as to perform paper feeding of a desired amount (distance).

It may be determined freely whether to select a reflection sensor or a transmission sensor to read an encoder.

According to the embodiment of the present invention, the surface resistivity of the surface of a recording medium which surface comes into contact with a conveyor belt falls within the range of 1×10⁹ to 9×10¹²Ω, preferably, 1×10⁹ to 9×10¹¹Ω, under 23° C./50% RH condition.

In general, in the case of performing recording on a recording medium having an ink absorbing layer formed on a base body of high surface resistivity, the surface (base body surface) of the recording medium which surface has been in contact with a conveyor belt is charged. As a result, the recording medium that is being conveyed electrostatically adheres to recording media already ejected and stacked in a paper ejection tray part with images formed thereon after recording. This may cause the recording media after recording to be pushed out, or may generate resistance against the conveyance of the recording medium that is being conveyed, thus adversely affecting the conveyability of the recording medium.

On the other hand, according to the embodiment of the present invention, the surface resistivity of the surface of a recording medium which surface comes into contact with a conveyor belt is set to 9×10¹²Ω or lower. As a result, the surface potential of the above-mentioned contact surface of the recording medium attenuates immediately, thus causing no adverse effect on the conveyability and stackability of the recording medium. Further, according to the embodiment of the present invention, the surface resistivity of the contact surface of the recording medium is set to 1×10⁹Ω or higher. As a result, sufficient electrostatic attraction to the conveyor belt is secured, thus preventing the occurrence of skewed feeding due to insufficient electrostatic attraction or a decrease in conveyance accuracy.

Referring to FIGS. 4 and 5, according to the embodiment of the present invention, an AC bias is applied to the charging roller 25 so that positive and negative charges are alternately generated parallel to the sub scanning direction on the conveyor belt 21. As a result, the paper sheet 11 is electrostatically fixed to the conveyor belt 21 by electric field represented by electric lines of force 41 led from the positive to negative charges on the conveyor belt 21, thereby generating an attraction force.

That is, by applying electric charges to the conveyor belt 21 with alternating current, it is possible to charge the conveyor belt 21 while erasing the history of electric charges that have already been thereon. Further, in actual charging, discharge occurs in a minute gap atmosphere between a conveyor belt and a charged object (recording medium), and at the same time, a region to which an electric charge is applied has a certain width. That is, in the case of attempting accurate control of a charging width, if application of electric charges continues even after the conveyor belt is stopped, the past history may be erased for an uncertain width, or the electric charges may be applied in an undesired direction. Further, a current flowing at the time of charging, although extremely small in amount, may generate heat on the conveyor belt to induce the generation of pin holes, which may lead to leakage.

According to the embodiment of the present invention, it is possible to control a charging width accurately with respect to a conveyor belt so as to eliminate the risk of damaging the conveyor belt.

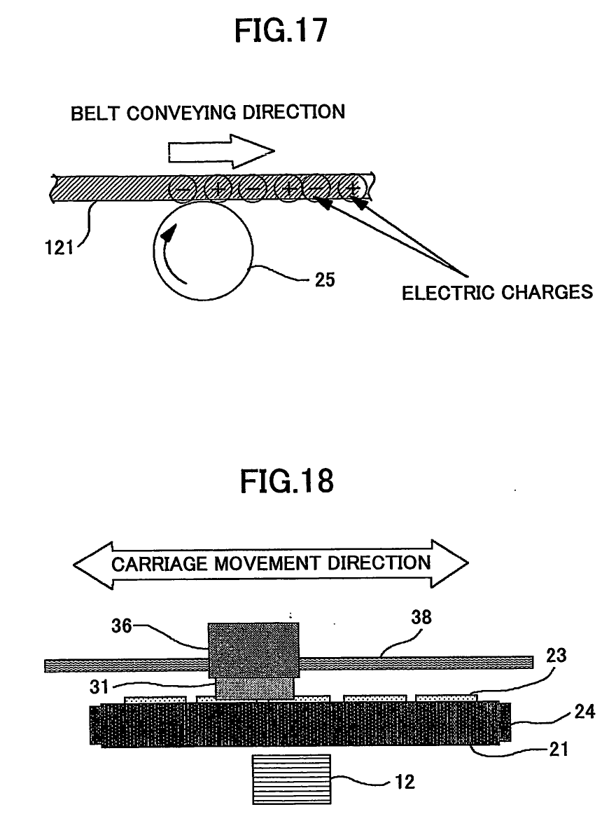

On the other hand, in the case of employing a single-layer conveyor belt 121 formed only of an insulating layer as shown in FIGS. 16 and 17, the electrostatic attraction force of the conveyor belt 121 to attract the paper sheet 11 is weak so that the conveyance of the paper sheet 11 may not be ensured.

According to the embodiment of the present invention, when the ink-jet recording printer (for instance, of FIG. 6) receives an instruction to output an image, the paper feed roller 12 and the paper separation pad 13 separate and convey the paper 11 placed on the paper stacking tray 14 sheet by sheet so that each paper sheet 11 is guided to the conveyor belt 21 by the paper conveyance guide 22. At this point, as described above, the conveyor belt 21 is charged alternately positively and negatively by the charging roller 25. The paper sheet 11 is conveyed with high accuracy between the conveyor belt 21 and each of a paper press roller 27 (FIG. 6) and the edge rollers 23. Referring to FIG. 18, when the paper sheet 11 is positioned immediately below the head 31, the carriage 36 starts to move back and forth along the main scanning direction as indicated by arrows so as to form an image. When the carriage 36 is moving back and forth for image formation, the operation of the conveyor belt 21 is stopped so that the paper sheet 11 remains stationary. When printing is over for a portion of the paper sheet 11 which portion is immediately below the head 31, the conveyor (driving) roller 24 is again driven to rotate the conveyor belt 21 so as to prepare for next printing. When the paper sheet 11 is stopped, the carriage 36 and the head 31 operate to form an image.

Thus, an image is formed on the paper sheet 11, and the paper sheet 11 is conveyed further downstream. The direction in which the conveyor belt 21 moves is changed by the tension roller (driven roller) 26. The paper sheet 11 is separated from the conveyor belt 21 because of the curvature of the tension roller 26 and the stiffness of the paper sheet 11 so as to be guided to a paper ejection tray 51 (a part to which output paper is ejected). At this point, power for conveying the paper sheet 11 is obtained basically from the electrostatic attraction force generated between the paper sheet 11 and the conveyor belt 21 and the rotation of the conveyor belt 21. At the time of image formation, the paper sheet 11 is conveyed without necessity for a pressing force from the side of its surface on which an image is formed.

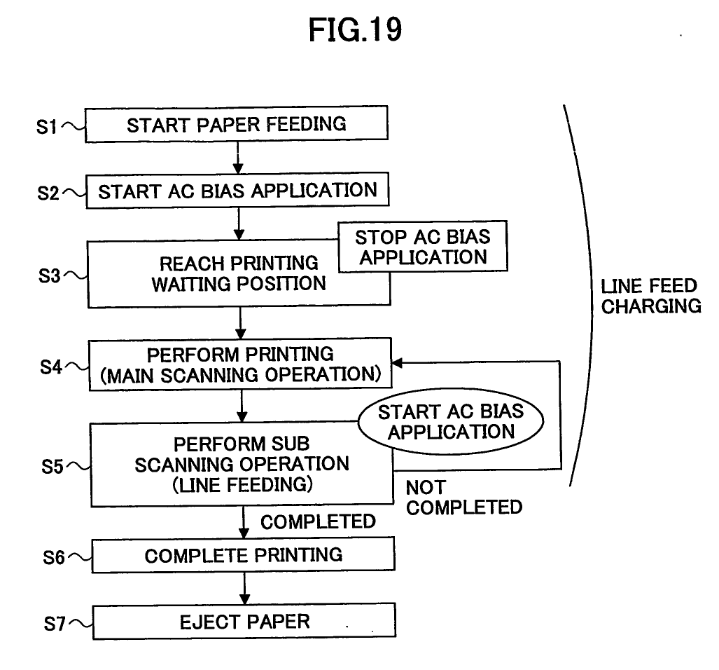

FIG. 19 is a flowchart for illustrating timing for applying AC bias to the conveyor belt 21 when the paper sheet (recording medium) 11 is stopped during its conveyance. FIG. 19 shows that the application of AC bias to the charging roller 25 is performed when the feeding of the paper sheet 11 is stopped before and after printing (writing) operations. First, in step S1, the feeding of the paper sheet 11 is started, when, in step S2, the application of AC bias to the charging roller 25 (the conveyor belt 21) is started. In step S3, when the paper sheet 11 reaches a waiting position for printing, the application of AC bias is stopped. Then, in step S4, printing is performed in the main scanning direction. When the printing of step S4 is completed, in step S5, the conveyor belt 21 is rotated to move in the sub scanning direction for line feeding, while the application of AC bias to the charging roller 25 is again started. Steps S4 and S5 are repeated until printing is completed for the paper sheet 11 in step S6. Then, in step S7, the paper sheet is ejected. The charging performed between steps S1 and S7 is referred to as line feed charging.

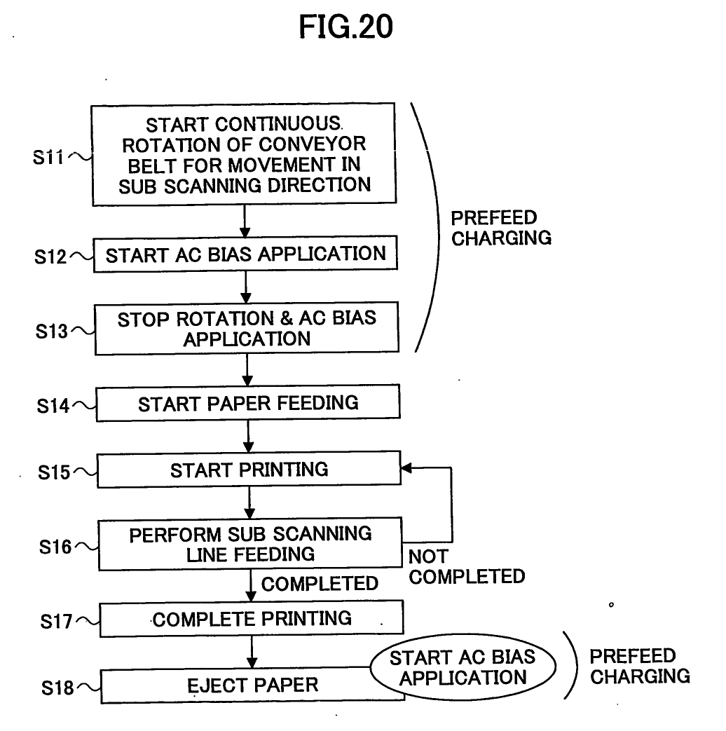

Next, FIG. 20 is another flowchart for illustrating timing for applying AC bias to the conveyor belt 21. FIG. 20 shows that the application of AC bias to the charging roller 25 is performed when a paper feed system is in continuous operation for paper feeding.

In step S11, the continuous rotation of the conveyor belt 21 is started to move the conveyor belt 21 in the sub scanning direction, when, in step S12, the application of AC bias to the charging roller 25 (the conveyor belt 21) is started. In step S13, the rotation of the conveyor belt 21 and the application of AC bias are stopped, when, in step S14, the feeding of the paper sheet 11 is started. In step S15, printing is started, and when the printing of step S15 is completed, in step S16, the conveyor belt 21 is rotated to move in the sub scanning direction for line feeding. Steps S15 and S16 are repeated until printing is completed for the paper sheet 11 in step S17. Then, in step S18, the paper sheet is ejected, and the application of AC bias to the charging roller 25 is started. The charging performed between steps S11 and S13 and in step S18 is referred to as prefeed charging.

According to the embodiment of the present invention, while the conveyor belt 21 is in continuous operation, the application of AC bias is performed so as to store electric charges on the conveyor belt 21. As a result, desired positively and negatively charged regions can be formed on the conveyor belt 21 with accuracy, and AC bias application can be controlled easily.

According to the embodiment of the present invention, multiple projections may be provided on the surface of the conveyor roller 24 and/or the tension roller 26.

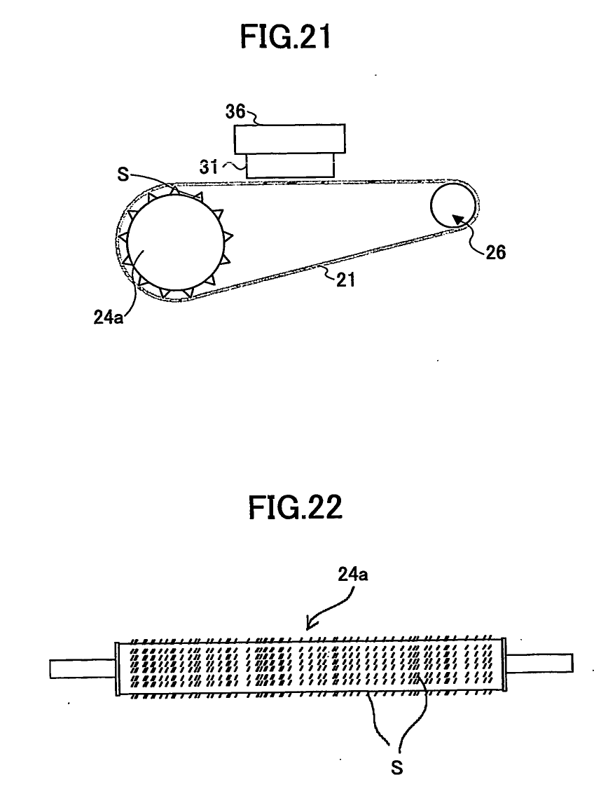

FIG. 21 is a schematic diagram showing a conveyance unit employing a grip roller 24a instead of the conveyor roller 24 according to the embodiment of the present invention. FIG. 22 is a schematic diagram showing the grip roller 24a.

The grip roller 24a has multiple projections S provided on its surface. In the case of employing the grip roller 24a, the projections S of the grip roller 24a bite the conveyor belt 21 or the paper sheet 11 so as to prevent the occurrence of slippage between the grip roller 24a and the conveyor belt 21 or the paper sheet 11.

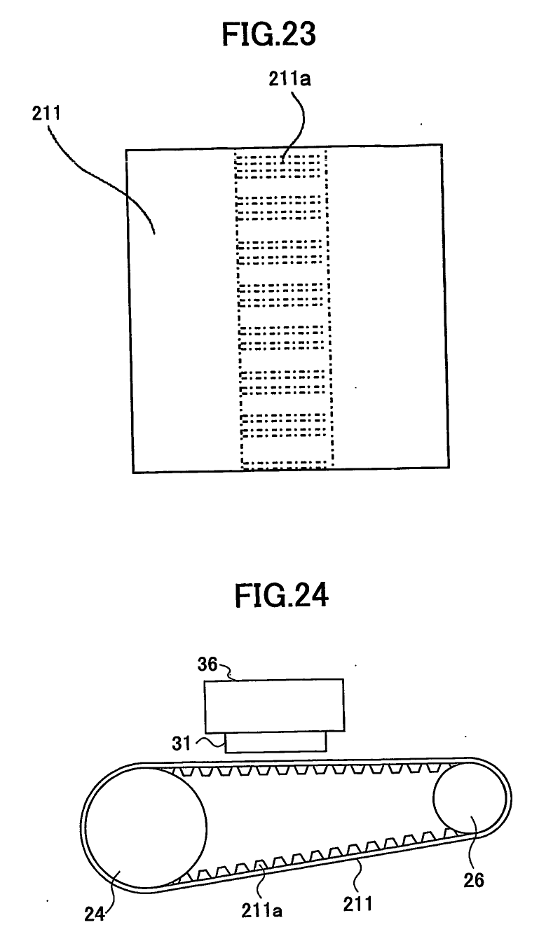

Next, FIG. 23 is a schematic diagram showing a conveyor belt 211 including a timing belt part 211a. FIG. 24 is a schematic diagram showing an application of the conveyor belt 211. The conveyor belt 211 has at least part of an inner surface thereof formed by the timing belt part 211a. If a timing pulley is provide to at least part of the conveyor roller 24, no slippage occurs between the conveyor roller 24 and the conveyor belt 211, and the conveyor belt realizes highly accurate conveyance not only in one direction but also in the other direction at the time of reverse conveyance.

According to the embodiment of the present invention, the surface resistivity of the surface (contact surface) of a recording medium which surface comes into contact with a conveyor belt falls within the range of 1×10⁹ to 9×10¹²Ω. The recording medium having a contact surface whose surface resistivity falls within such a range may be formed by including an antistatic agent in the base body of the recording medium by internal addition. Alternatively, the recording medium may also be formed by having coating liquid containing an antistatic agent included in or applied on the base body of the recording medium by coating such as roll coating, blade coating, or air knife coating.

Preferred antistatic agents employed in the embodiment of the present invention include: alkali metal salts such as sodium chloride, potassium chloride, lithium chloride, and sodium sulfate, alkaline earth metal salts such as calcium chloride and barium chloride, colloidal metal oxides such as colloidal silica and colloidal alumina, and conductive fine particle metal oxides such as tin oxide, titanium oxide, and zinc oxide as inorganic antistatic agents; and organic salts such as poly(sodium ethylenesulfonate), sodium styrene maleic anhydride, poly(2-acrylamide-sodium 2-methylsulfonate), poly(vinylbenzyltrimethylammonium chloride), and sodium sulfamate, organic electrolytes, and antistatic agents using a siloxane bond as organic antistatic agents. As the antistatic agents using a siloxane bond, chemical complexes of a vinyl polymer including a silyl group and polysiloxane are preferred because variations due to environmental conditions are small in those chemical complexes and their adhesiveness to plastic films is excellent.

The amount of the antistatic agent included in or applied to the base body is suitably controlled based on the material and thickness of the base body, the types of other additives and their amount of inclusion, and the properties of the base body, and is not limited to a specific value. In general, the amount of conductive material included falls within the range of 0.01 to 10 g/m², preferably, 0.1 to 5 g/m².

There is no specific limitation on the base body of a recording medium according to the embodiment of the present invention. A sheet-like base body used in the conventional recording medium may be employed as it is. For instance, polyolefin or polystyrene synthetic paper, woodfree paper, art paper, coated paper, cast-coated paper, wall paper, backing paper, synthetic resin impregnated paper, emulsion impregnated paper, synthetic rubber impregnated paper, synthetic resin containing paper, paperboard, cellulose fiber paper, and various transparent plastic films or sheets of polyolefin, polyvinyl chloride, polyethylene terephthalate, polystyrene, polymethacrylate, and polycarbonate may be employed. Further, white opaque films formed by adding white pigment and filler to the above-described synthetic resins and foamed sheets formed by foaming the above-described synthetic resins may also be employed. A layered body of any combination of the above-described base material films, such as a layered body of cellulose fiber paper and synthetic paper or a layered body of cellulose fiber paper and a plastic film, may also be employed. If such base bodies have poor adhesiveness to an ink absorbing layer or an antistatic agent layer formed thereon, it is preferable to perform primer processing or corona discharge processing on the surfaces of the base bodies.

There is no particular restriction on the thickness of the base body employed in the embodiment of the present invention. However, considering a feeling to the touch and elasticity, the base body is preferably 20 to 300 μm in thickness. More preferably, the base body is 40 to 250 μm in thickness so as to produce remarkable effects according to the present invention.

The recording medium according to the embodiment of the present invention may be composed of only a base body if the base body has ink absorbability. However, it is preferable that at least one ink absorbing layer be formed on the base body to obtain a high quality image. There are two common types of ink absorbing layers. One type has an air gap layer, being formed mainly of solid particles. The other type is formed mainly of a polymer that swells or dissolves in water or a solvent included in ink. Either type of ink absorbing layer is employable in the recording medium according to the embodiment of the present invention.

Next, a description is given below of specific examples of the recording medium and ink according to the present invention and their comparative examples. However, the present invention is not limited to the below-described specific examples.

[Production of Recording Medium]

(Recording Medium 1)

First, 100 g of alumina sol of a solid content of 18 wt % synthesized by hydrolysis and peptization of aluminum alkoxide and 32 g of an aqueous solution of 6.2 wt % polyvinyl alcohol were mixed to form a coating liquid. The coating liquid was applied on a polyethylene terephthalate film (100 μm in thickness, transparent) using a bar coater so that the amount of coating would become 26 g/m² after drying, and was dried. As a result, a pseudoboehmite layer (ink absorbing layer) was formed.

Next, silica sol coating liquid of a solid content of 5 wt % composed of silica sol of 10 to 20 nm in primary particle size and a polyvinyl alcohol copolymer including a silanol group (R-polymer R-1130 [product name]; manufactured by Kuraray Co., Ltd.) (the copolymer/SiO²=0.3) was applied on the surface (bottom surface) of the base material (polyethylene terephthalate film) on the side opposite to the side of the surface on which the ink absorbing layer was formed so that the amount of coating of a silica gel layer formed after drying would become 1 g/m². Thereafter, the silica sol coating liquid was subjected to drying and heat treatment at 140° C.

The surface resistivity of the ink absorbing layer (pseudoboehmite layer) surface was 9×10¹¹Ω, and the surface resistivity of the bottom surface was 3×10¹²Ω.

The measurement of surface resistivity was performed based on JIS K 6911. Specifically, the measurement was performed using 4329A HIGH RESISTANCE METER and 16008A RESISTIVITY CELL manufactured by Yokogawa Hewlett-Packard, Ltd. after charging of one minute with an applied voltage of 100 V. The environment at the time of humidification of a recording medium and measurement of surface resistivity was 23±1° C. and 50±2% RH. This was the same in the following.

(Recording Medium for Comparison 1)

First, 100 g of alumina sol of a solid content of 18 wt % synthesized by hydrolysis and peptization of aluminum alkoxide and 32 g of an aqueous solution of 6.2 wt % polyvinyl alcohol were mixed to form a coating liquid. The coating liquid was applied on a polyethylene terephthalate film (100 μm in thickness, transparent) using a bar coater so that the amount of coating would become 26 g/m² after drying, and was dried. As a result, a pseudoboehmite layer (ink absorbing layer) was formed. Then; the pseudoboehmite layer was subjected to heat treatment at 140° C.

The surface resistivity of the bottom surface of the base material was 2×10¹⁵Ω.

(Recording Medium 2)

[Manufacturing of Antistatic Agent Using Siloxane Bond]

A solution in which 100 parts of butyl methacrylate (hereinafter, BMA), 3 parts of azobis(isobutylonitrile) (hereinafter, AIBN), and 2 parts of n-dodecyl mercaptan were dissolved was added dropwise to 90 parts of toluene heated to 100° C. in 6 hours, and was subjected to reaction for 2 hours. As a result, a BMA polymer of a molecular weight of 5000 was obtained. Next, liquid formed by dissolving 2.5 parts of methyldimethoxysilane and 0.0005 parts of chloroplatinic acid in isopropanol was added to 30 parts of the obtained BMA polymer, which was hermetically sealed at a temperature of 90° C. and subjected to reaction for 8 hours. As a result, a BMA polymer including a silyl group was obtained. Further, 25 parts of water, 35 parts of ortho-ethyl silicate, and 0.5 parts of a concentrated hydrochloric acid were mixed and subjected to reaction at 60° C. for 5 hours. As a result, a polysiloxane solution was obtained. Then, 100 parts of the polysiloxane solution was added to 20 parts of the BMA polymer including a silyl group, and the mixture was stirred at room temperature for 30 minutes for reaction. After adding 40 parts of ethyl acetate, 20 parts of n-butanol, and 20 parts of cyclohexanone to the mixture, the mixture was allowed to stand for 24 hours. As a result, an antistatic agent was obtained.

Then, 100 g of alumina sol of a solid content of 18 wt % synthesized by hydrolysis and peptization of aluminum alkoxide and 32 g of an aqueous solution of 6.2 wt % polyvinyl alcohol were mixed to form a coating liquid. The coating liquid was applied on a polyethylene terephthalate film (100 μm in thickness, transparent) using a bar coater so that the amount of coating would become 26 g/m² after drying, and was dried. As a result, a pseudoboehmite layer (ink absorbing layer) was formed.

Next, the above-described antistatic agent liquid using the siloxane bond was applied on the bottom side of the base material (polyethylene terephthalate film) so that the amount of coating would become 1 g/m² after drying, and was dried.

The surface resistivity of the bottom surface of the base material was 3×10¹⁰Ω.

(Recording Medium 3)

First, 100 g of alumina sol of a solid content of 18 wt % synthesized by hydrolysis and peptization of aluminum alkoxide and 32 g of an aqueous solution of 6.2 wt % polyvinyl alcohol were mixed to form a coating liquid. The coating liquid was applied on a polyethylene terephthalate film (100 μm in thickness, transparent) using a bar coater so that the amount of coating would become 26 g/m² after drying, and was dried. As a result, a pseudoboehmite layer (ink absorbing layer) was formed.

Next, a coating liquid having the below-described composition was applied on the bottom side of the base material (polyethylene terephthalate film) so that the amount of coating would become 5 g/m² after drying, and was dried.

Composition:
Fumed silica (AEROSIL 200, manufactured by Nippon Aerosil Co., Ltd.): 100 parts
Polyvinyl alcohol (PVA-117, manufactured by Kuraray Co., Ltd.): 50 parts
Dimethyldiallylammonium chloride homopolymer (SHALLOL DC902P, manufactured by Dai-ichi Kogyo Seiyaku Co., Ltd.): 6 parts

The surface resistivity of the bottom surface of the base material was 2×10⁹Ω.

(Recording Medium for Comparison 2)

Coating liquid having the below-described composition was applied on the bottom side of Recording Medium for Comparison 1 so that the amount of coating would become 5 g/m² after drying, and was dried.

Composition:
Fumed silica (AEROSIL 200, manufactured by Nippon Aerosil Co., Ltd.): 100 parts
Polyvinyl alcohol (PVA-117, manufactured by Kuraray Co., Ltd.): 50 parts
Antistatic polymer (zirconium oxychloride, manufactured by Nippon Light Metal Co., Ltd.): 10 parts

The surface resistivity of the bottom surface of the obtained recording medium was 4×10⁸Ω.

[Preparation of Ink]

(Ink 1)

An ink composition of the following formula was prepared, and was adjusted with a 10% lithium hydroxide aqueous solution so as to have a pH of 9. Thereafter, the ink composition was filtered with a membrane filter of 0.8 μm in average pore size so that an ink composition (Ink 1) was obtained.

Formula:
Polymer particles including a phthalocyanine pigment: 8.0 wt % (as a solid content)
Triethylene glycol: 22.5 wt %
Glycerol: 7.5 wt %
2-pyrolidone: 5.0 wt %
Surface active agent CH₃(CH₂)₁₂O(CH₂CH₂O)₃CH₂COOH: 2.0 wt %
2-ethyl-1,3-hexanediol: 2.0 wt %
PROXEL LV (antiseptic): 0.2 wt %
Ion exchanged water: Balance

(Ink 2)

The preparation of Ink 2 was equal to that of Ink 1 except that an ink composition of the following formula was employed. The ink composition was adjusted with sodium hydroxide so as to have a pH of 9, so that an ink composition (Ink 2) was obtained.

Formula:
Polymer particles including a dimethyl quinacridone: 8.0 wt % (as a solid content)
Propylene glycol: 30.0 wt %
Glycerol: 10.0 wt %
N-methyl-2-pyrolidone: 2.0 wt %
Surface active agent CH₃(CH₂)₁₂O(CH₂CH₂O)₄CH₂COOH: 2.0 wt %
2,2,4-trimethyl-1,3-pentanediol: 2.0 wt %
PROXEL LV (antiseptic): 0.2 wt %
Ion exchanged water: Balance

(Ink 3)

The preparation of Ink 3 was equal to that of Ink 1 except that an ink composition of the following formula was employed. The ink composition was adjusted with lithium hydroxide so as to have a pH of 9, so that an ink composition (Ink 3) was obtained.

Formula:
Polymer particles including a monoazo yellow pigment: 8.0 wt % (as a solid content)
1,3-butanediol: 22.5 wt %
Glycerol: 7.5 wt %
2-pyrolidone: 5.0 wt %
Surface active agent CH₃(CH₂)₁₂O(CH₂CH₂O)₆CH₂COOH: 2.0 wt %
2,2,4-trimethyl-1,3-pentanediol: 2.0 wt %
PROXEL LV (antiseptic): 0.2 wt %
Ion exchanged water: Balance

Next, using the above-described recording media and Inks 1 through 3, recording was performed with an ink-jet recording apparatus having the configuration of FIG. 6. The conveyor belt employed has a conductive layer of 110 μm in thickness formed on a surface of an ETFE resin sheet (an insulating layer) of 40 μm in thickness by coating the surface of the ETFE resin sheet with conductive resin liquid of the same ETFE resin in which carbon black is contained. The volume resistivity of the insulating layer of the conveyor belt is 1×10¹⁵Ω·cm, and the volume resistivity of the conductive layer of the conveyor belt is 2×10⁵Ω·cm. The recording was performed with a charging bias of ±2.0 kV, a charging width of 8 mm, and a conveyor belt moving speed of 200 mm/s.

As a result, Recording Medium for Comparison 1, while being conveyed, electrostatically adhered to a recording medium that had already been ejected onto the paper ejection part, and pushed out the recording medium after recording. On the other hand, Recording Media 1, 2, and 3 according to the present invention did not adhere to a recording medium that had already been ejected on the paper ejection part, and showed good stackability in the paper ejection part.

In the case of Recording Medium for Comparison 2, its adhesiveness to the conveyor belt was insufficient so that skewed feeding occurred. The antistatic agent layer of Recording Medium 2 according to the present invention in particular showed good adhesiveness to the base body.

Thus, according to the ink-jet recording method of the present invention, image quality can be improved without providing a spur on the side of the printing surface of a recording medium. Further, cockling, which may occur when the recording medium is plain paper or coated paper having an ink absorbing layer formed on a paper base, can be controlled. Furthermore, the stackability of the recording medium after recording can be improved. Further, the application of AC bias to a charging roller may be stopped when a conveyor belt remains stationary. Accordingly, electrostatic attraction can be performed stably without removing charges on the conveyor belt. Further, the possibility of damaging the conveyor belt is reduced. In addition, the application of AC bias to the charging roller may be performed at the time of paper feeding. Therefore, electrostatic attraction can be performed stably without affecting printing throughput.

According to the recording medium of the present invention, paper transportation can be performed smoothly. As a result, good image quality can be obtained.

The present invention is not limited to the specifically disclosed embodiment, and variations and modifications may be made without departing from the scope of the present invention.

The present application is based on Japanese priority patent applications No. 2003-158507, filed on Jun. 3, 2003, and No. 2004-162241, filed on May 31, 2004, the entire contents of which are hereby incorporated by reference.

1. An ink-jet recording method for performing recording on a recording medium by attaching ink thereto, the recording medium adhering to a conveyor belt because of electrostatic attraction thereto, wherein:
the electrostatic attraction is caused by charging means, the charging means applying AC bias to the conveyor belt so that positive and negative charges are provided on the conveyor belt so as to alternate with each other in a direction in which the conveyor belt moves; and
a surface of the recording medium which surface comes into contact with the conveyor belt has surface resistivity that falls within a range of 1×10⁹ to 9×10¹²Ω.

2. The ink-jet recording method as claimed in claim 1, wherein:
the conveyor belt engages a driving roller and a driven roller to extend therebetween, the conveyor belt conveying to an image recording part the recording medium separated and fed from a recording medium feeding unit; and
at least a side of the conveyor belt which side comes into contact with the recording medium includes an insulating layer.

3. The ink-jet recording method as claimed in claim 1, wherein the application of the AC bias to the conveyor belt is stopped when the recording medium remains stationary during conveyance thereof.

4. The ink-jet recording method as claimed in claim 1, wherein the AC bias is applied to the conveyor belt while the conveyor belt is driven continuously before conveying the recording medium.

5. A recording medium to be employed in an ink-jet recording method for performing recording on the recording medium by attaching ink thereto, the recording medium adhering to a conveyor belt because of electrostatic attraction thereto, wherein:
a surface of the recording medium which surface comes into contact with the conveyor belt has surface resistivity that falls within a range of 1×10⁹ to 9×10¹²Ω.
